(19) United States
(12) Patent Application Publication
(10) Pub. No.: US 2006/0268251 A1
(43) Pub. Date: Nov. 30, 2006

(54) Illumination system for a microlithographic projection exposure apparatus

(76) Inventors: Markus Deguenther, Aalen (DE); Manfred Maul, Aalen (DE); Damian Fiolka, Oberkochen (DE)

Correspondence Address: SUGHRUE MION, PLLC, 2100 PENNSYLVANIA AVENUE, N.W., SUITE 800, WASHINGTON, DC, 20037, US

(21) Appl. No.: 10/564,639

(22) PCT Filed: Jul. 15, 2004
(86) PCT No.: PCT/EP04/07926

§ 371 Date: May 8, 2006

Related U.S. Application Data
(60) Provisional application No. 60/487,709, filed on Jul. 16, 2003.
(60) Provisional application No. 60/487,708, filed on Jul. 16, 2003.
(60) Provisional application No. 60/548,123, filed on Feb. 26, 2004.

(51) Int. Cl. G03B 27/54

(52) U.S. Cl. 355/67

(57) ABSTRACT

An illumination system for a microlithographic projection exposure apparatus includes a light source (12) for generating a projection light beam, a first objective (20) and a masking system (38, 52) for masking a reticle (30). The masking system (38, 52) includes adjustable first blades (40) for masking in a first spatial direction (X) and adjustable second blades (54, 56) for masking in a second spatial direction (Y). The first blades (40) are arranged in the region of a first field plane (36) and the second blades (54, 56) are arranged in the region of a second field plane (44) which is different to the first field plane (36). The masking system can therefore be made spatially less concentrated, whereby constructional difficulties in the region of the field plane before the masking objective resulting from space requirement problems are reduced. A further contribution is made to solving the space requirement problem if an attenuation system for achieving the most uniform possible light intensity in the wafer plane (122) includes a transmission filter (162) which has locally varying transmissivity and can be moved synchronously with traversing movements of the reticle (30).

### CROSS-REFERENCE TO RELATED APPLICATIONS

This is a National Stage of International Application PCT/EP2004/007926 filed Jul. 15, 2004 and claiming benefit of U.S. Provisional Applications Nos. 60/487,709 and 60/487,708, both filed Jul. 16, 2003, and 60/548,123 filed Feb. 2004.

### BACKGROUND OF THE INVENTION

1. Field of the Invention

The present invention relates to an illumination system for a microlithographic projection exposure apparatus. Such apparatuses are used for the manufacture of highly integrated electrical circuits and other micro-structured devices.

2. Description of Related Art

Illumination systems for microlithographic projection exposure apparatuses serve to generate a projection light beam which is directed on to a reticle containing the structures to be projected. With the aid of a projection lens these structures are imaged in reduced form on a light-sensitive surface which may be applied, for example, to a wafer.

An illumination system known from U.S. Pat. No. 6,285,443 A includes a laser serving as the light source, a beamforming system, a zoom-axicon objective for adjusting various types of illumination, together with a light mixing rod with which the projection light generated by the laser is mixed and homogenized. Arranged behind the light mixing rod in the light propagation direction is a masking system for defining the geometry of the light field passing through the reticle.

In known masking systems, as described, for example, in U.S. Pat. No. 5,473,410 A, the extension of the light field on the reticle in a first spatial direction is defined by a first pair of blades, the spacing of which is variable. A second pair of blades, the spacing of which is likewise variable, defines the extension of the light field in the spatial direction perpendicular thereto. By means of a following reticle masking objective the blades of the masking system are imaged on the reticle to be illuminated, where they generate a sharp-edged boundary of the light field.

Modern projection exposure apparatuses are frequently (also) designed for a scanning operation in which the reticle is moved past a light exit aperture of the illumination system in such a way that a narrow strip of light passes across the reticle in a scanning manner. Such a scanning mode requires that at the beginning and end of each scanning process one of the blades of the masking system arranged perpendicularly to the scanning direction is displaced along the scanning direction, so that the entire area of the reticle to be illuminated is exposed to the same irradiation. Irradiation is understood in photometry to mean radiation energy per unit area. For this reason irradiation is sometimes referred to as the radiation dose.

Because high scanning velocities occur in modern projection exposure apparatuses with a view to high throughput, the blades displaceable in the scanning direction are subjected to high dynamic loading. The mechanism in the masking systems required for this displacement is therefore constructionally relatively complex and expensive to manufacture, and requires, in addition, relatively large installation space inside the illumination system. The arrangement of other, neighboring optical elements can therefore be difficult.

Such an optical element may be, for example, an attenuation system for locally variable attenuation of the light intensity, as known, for example, from U.S. Pat. No. 5,895,737 A. This known attenuation system has to be arranged in the field plane of the illumination system in which the masking system is located, and includes a plurality of finger-like small blades which are movable individually into the light field. By means of the blades the light intensity on the reticle can be adapted in a specified manner to the structures to be projected during the scanning process.

However, the practical implementation of the joint system of a masking system with an attenuation system of this kind in the field plane in front of the masking objective presents considerable difficulties because of space requirement problems. The mechanism with which the numerous blades are individually movable has a relatively large space requirement.

On the other hand, the problem of light homogeneity in the reticle and wafer planes is gaining increasing importance. One reason for this is the increasingly frequent use of illumination systems in which an array of microlenses is used instead of a light mixing rod. Such microlens arrays have a tendency to illuminate the reticle less uniformly than light mixing rods. Increasing importance will therefore be attached in the future to additional measures for achieving the greatest possible light homogeneity.

Another problem frequently occurred in illumination systems is related to optical raster elements that are used to increase the light conductance value of the illumination system. The light conductance value, which is also referred to as geometrical optical flux, is defined as the product of field size and numerical aperture. Since it is not possible to increase the light conductance value with conventional lenses or mirrors, raster elements with two-dimensional raster structures are provided in known illumination systems. These raster elements may for example be diffractive optical elements such as gratings or refractive optical elements, for example microlens arrays.

In the illumination system known from the aforementioned U.S. Pat. No. 6,285,443 A, a first optical raster element is arranged in the exit pupil of the zoom-axicon objective and a second optical raster element is arranged in the object plane of this objective. In this arrangement, however, the two axicon lenses do not lie exactly in a pupil plane since this position is already occupied by the first optical raster element.

Principally this offset in relation to the ideal position in the pupil plane should not very important since the optical beam path is essentially parallel in this region of the objective. The parallelism is only approximate, however, since the light emitted by laser that is used as a light source has a—albeit only slight—divergence. This divergence is caused by the finite overall length of the laser. Since the light exit face of the laser generally has the shape of a rectangle, this divergence is also rotationally asymmetric. As a consequence, the illumination produced by the axicon lenses in a subsequent pupil plane is no longer exactly rotationally symmetric, for example annular, but slightly elliptical. This effect disturbs the illumination angle distribution in the reticle plane, so that the imaging of the reticle on the photosensitive layer is compromised.

### SUMMARY OF THE INVENTION

It is therefore a first object of the invention to provide an illumination system in which the constructional difficulties resulting from space requirement problems in the region of the field plane before the masking objective are reduced.

It is another object of the invention to provide an illumination system in which undesired disturbances of the illumination angle distribution caused by axicon lenses are reduced.

The first object is achieved according to a first aspect of the invention with an illumination system comprising a light source for generating a projection light beam, a first objective and a masking system for masking a reticle. The masking system includes adjustable first blades for masking in a first spatial direction. The first blades are arranged in or in close proximity to a first field plane. The masking system further includes adjustable second blades for masking in a second spatial direction. The second blades are arranged in or in close proximity of a second field plane which is different from the first field plane.

This distribution of the blades provided for the different spatial directions to different field planes makes it possible to make the masking system spatially less concentrated. The mechanism in the masking system required for the adjustability of the blades can therefore be constructed more simply and thus at lower cost. In addition, the distribution of the masking system to two field planes according to the invention allows units, such as the above-mentioned attenuation system, which must be arranged in a field plane, to be integrated into the illumination system more easily.

The first and second field planes may be directly adjacent, i.e. without further interposed field planes, and may be imaged on one another by a single objective. In principle, however, it is also possible for further field planes which are imaged on one another by a corresponding number of additional objectives to be located between the two field planes.

The illumination system according to the invention can be realized especially simply if the first objective images a first optical raster element, arranged before the first objective in the beam propagation direction, on the first field plane, and if the illumination system also has a second objective arranged behind the first objective in the beam propagation direction, which second objective images the first field plane on the second field plane. The first optical raster element may be, for example, a refractive element, e.g. of the type of a microlens array, a diffractive element (grating), a kinoform or a hologram. With such an optical raster element, known as such, the light distribution of the projection light beam emitted by the light source can be shaped to have a circular, annular or quadrupole divergence distribution.

In principle, it is possible for the divergence of the projection light beam to be so increased in the first objective with the aid of a suitable optical raster element that the maximum light conductance value of the entire optical system is already attained in that objective.

In another embodiment a second optical raster element, which expands a transiting projection light beam only in the first spatial direction, is arranged in the first objective. A third optical raster element which expands a transiting projection light beam only in the second spatial direction is arranged in the second objective. The second and third optical raster elements are preferably arranged in proximity to a pupil plane. Through the provision of two raster elements acting in different spatial directions, the maximum light conductance value of the optical system is attained only behind the third optical raster element. Between the second optical raster element and the third optical raster element the light conductance value is increased only in the first spatial direction. This enables the optical elements arranged between the second optical raster element and the third optical raster element to be constructed more simply and at lower cost, since the requirements for complexity and accuracy in optical elements increase with increasing light conductance value.

If a substantially strip-shaped light field, the extension of which in the first spatial direction is shorter than in the second spatial direction, is definable on the reticle by the first and second blades, the increase in the light conductance value introduced by the second optical raster element is hardly of importance, since in this case the second optical raster element expands the projection light beam by only a relatively small angular amount. For the optical elements located between the second and third optical raster elements this slight increase in the light conductance value in this first spatial direction is practically negligible.

This configuration of the invention has the additional advantage that the relatively complex and costly mechanism for the adjustment of the first blades, which limit the light field on the reticle in the first spatial direction (the scanning direction) and which must be precisely and rapidly displaced at the beginning and end of each scanning process, are given sufficient space in the free space remaining between the first objective and the second objective.

Only the blades which effect the masking in the spatial direction perpendicular thereto and which generally do not have to be adjusted during a scanning process must then be arranged in the second field plane. The mechanism required for this purpose is generally more simply constructed than the mechanism for adjusting the first blades, so that the smaller part of the masking system is arranged in the region of the second field plane.

This second field plane is therefore particularly suited to accommodating further optical assemblies which must be arranged in or close to a field plane. An example of such assemblies is the above-mentioned attenuation system.

In another advantageous embodiment the first and second objectives are so designed that the light field in the first field plane is smaller than the light field in the second field plane. This can be achieved, for example, in that the second objective has an imaging scale greater than one. A relatively small light field in the first field plane has the advantage that, to achieve the same masking effect on the reticle, the first blades arranged in that plane require shorter adjustment distances than if the first blades were arranged in the second field plane, where the light field is larger. With this refinement the dimensions of the first blades can also be selected smaller than is otherwise usual. The entire part of the masking system concerned with the first blades can therefore be constructed smaller and more compact, and therefore at lower cost.

On the other hand, there are other optical assemblies, e.g. the above-mentioned attenuation system, which should be arranged as in or close to a field plane in which the light field is comparatively large. With an attenuation device of the above-mentioned type it is scarcely possible to reduce the dimensions of the numerous small blades which can be introduced into the light field beyond the size already achieved.

In addition, a manipulator for manipulating the pupil may advantageously be arranged in the second objective. Such a manipulator may be, for example a grey-scale filter which may be arranged close to the pupil, e.g. adjacent to the third optical raster element, in the second objective. With other manipulators known as such in the state of the art the telecentricity, for example, may be changed.

The first objective can be a zoom-axicon objective having two axicon lenses adjustable relative to one another. The two axicon lenses may also be arranged in a pupil plane of the zoom-axicon objective. The second optical raster element, which should also be positioned close to the pupil, can then be arranged either directly before or behind the axicon lenses in the first objective.

To image the second field plane on a third field plane in which the reticle is arranged, a third objective of the kind known as such in the state of the art can be provided.

According to another aspect of the invention, the above-mentioned first object is achieved by a microlithographic projection exposure apparatus for imaging structures on a light-sensitive layer, which structures are contained in a movably arranged reticle. The projection exposure apparatus also includes a transmission filter which has locally varying transmissivity and is movable synchronously with the traversing movements of the reticle.

In this way the light intensity impinging on the reticle during a scanning process can be varied as desired, since to each point on the transmission filter there is coordinated one-to-one a point on the reticle. By such one-to-one coordination it is meant that to each point on the transmission filter there is coordinated precisely one point on the reticle and that, conversely, to each point on the reticle there is coordinated precisely one point on the transmission filter. Because such one-to-one coordination also exists between the points on the reticle and on the light-sensitive layer, it can be ensured that an area on the transmission filter exposed to the slit-shaped light field is always imaged on a corresponding area on the light-sensitive layer, and can contribute in this way to a local reduction of the light intensity.

A transmission filter which is arranged movably in this way has the advantage that it has only a very short extension along the optical axis, so that it can be arranged without major difficulty in proximity to a field plane in which movable blades of a masking system are also located. The adjusting mechanism required for moving the transmission filter is comparatively robust and, in addition, can be placed outside the optical path, simplifying its integration in existing designs of illumination systems. If the transmission filter is positioned exactly in a field plane, the telecentricity of the illumination system is also unchanged.

Furthermore, the traversing movements of a single relatively large transmission filter are considerably easier to implement than traversing movements of a multiplicity of movable blades, as is the case in the attenuation system known from U.S. Pat. No. 5,895,737 A. The problem arising in that disclosure, that inhomogeneities in the distribution of intensity within a blade width cannot be corrected, is not present with the solution according to the invention.

With the known attenuation system there is the further difficulty that, when the blades are moved very far into the light field, the times during which a given point on the moving reticle (and therefore on the wafer) is exposed to projection light can become so short that pulse quantization effects become noticeable. These effects are connected to the fact that lasers used as light sources are operated in a pulsed mode. If the time window for an exposure is very short it can make a considerable difference for the light quantity whether, for example, 6 or only 5 light pulses impinge on the point concerned. With the transmission filter according to the invention such pulse quantization effects cannot occur.

In principle, with such a transmission filter practically any desired distribution of light energy per unit area on the light-sensitive layer can be achieved. In a particularly advantageous embodiment, however, the local attenuation attainable with the aid of the transmission filter is selected such that all points on the light-sensitive layer which are to be exposed during a scanning process receive the same light energy per unit area. A simple additive relation therefore obtains between the transmission function of the filter, which describes the transmissivity as a function of location on the filter surface, on the one hand, and the necessary intensity correction at the corresponding points on the light-sensitive layer on the other.

As a location for mounting the movable transmission filter, a field plane in an illumination system which is conjugate to the image plane in which the reticle is arranged is particularly suitable. In many cases, however, it may be sufficient to arrange the transmission filter only in proximity to such a field plane.

To determine the transmission curve of the transmission filter, i.e. the dependence of transmissivity on the location on the surface of the transmission filter, a procedure comprising the following steps may be carried out:
a) arrangement of a light-sensitive element in the image plane;
b) projection of a reticle on the light-sensitive element under the conditions under which microstructured components are to be manufactured using the reticle, in a scanning process in which the light-sensitive element is moved synchronously with the reticle;
c) locally-resolved determination of the light energy impinging on the light-sensitive element per unit area;
d) determination of the smallest value of light energy which has been detected in step c) for a point to be exposed on the light-sensitive element;
e) provision of a traversing system for a transmission filter with locally varying transmissivity, with which traversing system the transmission filter can be moved synchronously with traversing movements of the reticle;
f) definition of the local distribution of the transmissivity of the transmission filter in such a way that, during a further projection in which the transmission filter is moved synchronously with the reticle, the smallest value for the light energy impinging per unit area determined in step c) is approximately achieved at all points to be exposed on a light-sensitive layer arranged in the image plane.

In this way the transmission curve of a transmission filter which is specifically adapted to the reticle can be determined with simple means for any desired reticle.

The above-mentioned second object of the invention is achieved by an illumination system comprising a light source and a first objective that has a first pupil plane and includes two axicon lenses which can be displaced relative to each other. A first optical raster element is arranged in an object plane of the first objective. A second objective is arranged in the optical path behind first objective and images the first pupil plane onto a second pupil plane. A second optical raster element is arranged in the second pupil plane.

The second objective thus provides a further pupil plane, in which the second optical raster element is arranged. Therefore, the axicon lenses can now be arranged exactly in a pupil plane of the first objective, so that the aforementioned disturbances of the illumination angle distribution are avoided.

Since the second objective is arranged before the second optical raster element in the beam propagation direction, this second objective can be constructed in a comparatively straightforward and inexpensive way. This is because the light conductance value is still relatively small in this region of the illumination system, as it is only increased to its maximal value by the second optical raster element.

Provision of the second objective, which may for example have a magnification of between about 0.5 and 2, also has the advantage of providing additional space close to a pupil plane between the second objective and the second optical raster element. Additional elements for manipulating the pupil can be provided in this space.

### BRIEF DESCRIPTION OF THE DRAWINGS

Various features and advantages of the present invention may be more readily understood with reference to the following detailed description taken in conjunction with the accompanying drawing in which:

FIG. 1 shows a meridional section of an illumination system according to the invention in a highly schematized representation which is not to scale;

FIG. 2 shows the geometry of a light field which can be generated by the illumination system shown in FIG. 1;

FIG. 3 is a plan view of the second optical raster element of the illumination system shown in FIG. 1;

FIG. 4 shows a section through the second optical raster element shown in FIG. 3 along the line IV-IV;

FIG. 5 is a plan view of the third optical raster element of the illumination system shown in FIG. 1;

FIG. 6 shows a section through the third optical raster element shown in FIG. 5 along the line VI-VI;

FIG. 7 shows a microlithographic projection exposure apparatus in a highly simplified meridional section according to another aspect of the invention;

FIG. 8 is a detailed representation corresponding to FIG. 1 of the illumination system shown in FIG. 7;

FIG. 9 is a plan view of a filter plane, a reticle plane and a wafer plane of the projection exposure apparatus shown in FIG. 1, no transmission filter being present in the filter plane, and

FIG. 10 is a representation corresponding to FIG. 9, but with a transmission filter present in the filter plane;

FIG. 11 shows a meridional section of an illumination system according to another aspect of the invention in a highly schematized representation which is not to scale.

### DESCRIPTION OF PREFERRED EMBODIMENTS

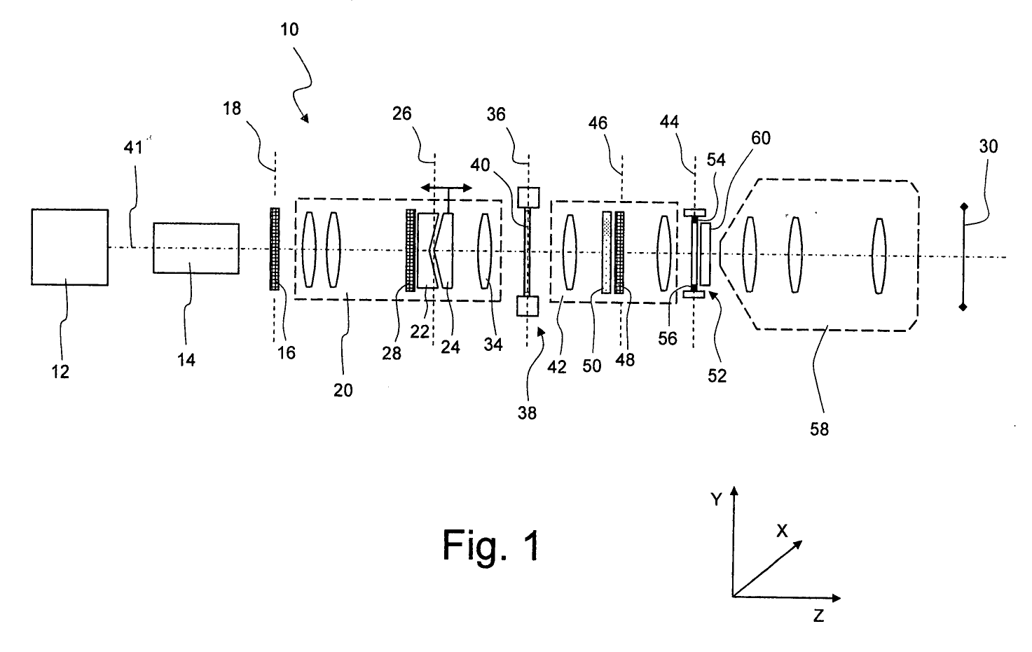

FIG. 1 shows an embodiment of an illumination system according to a first aspect of the invention. The illumination system, which is denoted in its entirety by 10, is shown in a meridional section in a highly simplified illustration which is not to scale. The illumination system 10 is provided for a projection exposure apparatus which enables exposure of light-sensitive surfaces in scanning operation. In principle, however, the illumination system 10 can also be used in projection exposure apparatuses which operate only intermittently.

The illumination system 10 has a light source 12, e.g. in the form of an excimer laser, which generates in this embodiment projection light having a wavelength in the ultraviolet spectral range, e.g. 193 nm or 157 nm. In a beam expander 14, which may be, for example, an adjustable mirror system, the projection light generated by the light source 12 is expanded to form a rectangular and substantially parallel ray bundle. The expanded projection light then passes through a first optical raster element 16, which may be, for example, a diffractive optical element having a two-dimensional raster structure. Other types of suitable optical raster elements are described, for example, in the above-mentioned U.S. Pat. No. 6,285,443 A which is incorporated by reference. With this first optical raster element 16 the divergence distribution of the projection light coming from the light source 12 can be reshaped to provide a circular, annular or quadrupole divergence distribution.

The first optical raster element 16 is arranged in an object plane 18 of a zoom-axicon objective 20 with which the illumination angle distribution can be varied. For this purpose the zoom-axicon objective 20 includes two axicon lenses 22, 24 which are displaceable relative to one another and are arranged in a pupil plane 26 of the zoom-axicon objective 20.

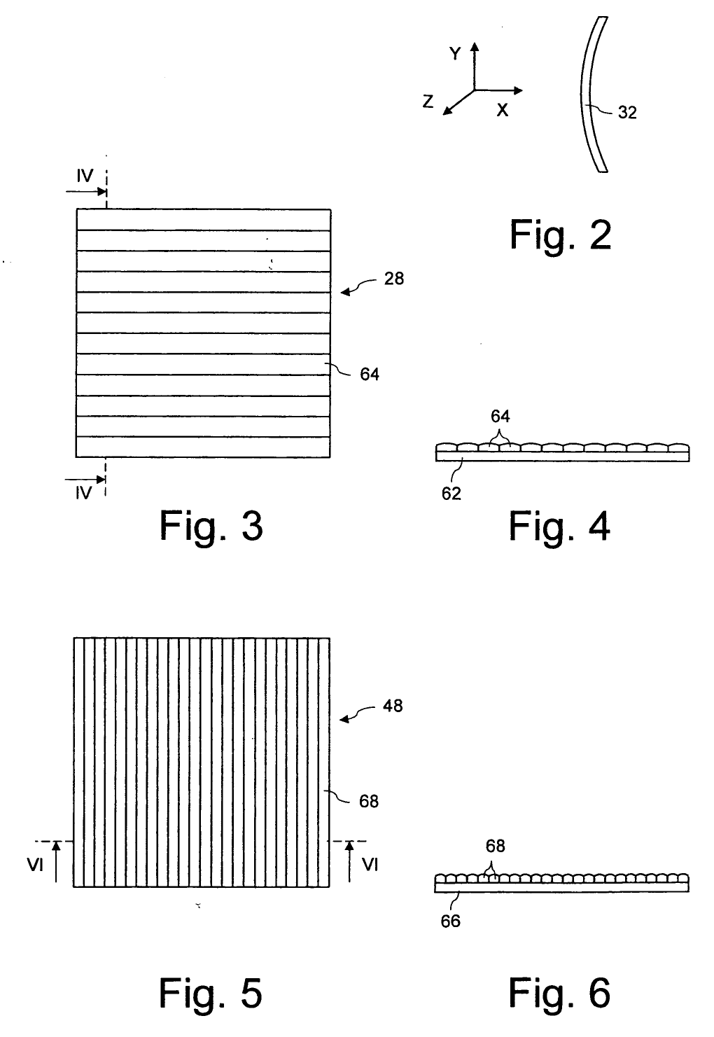

Directly before the two axicon lenses 22, 24, i.e. in proximity to the pupil plane 26, there is arranged a second optical raster element 28 by which a transiting projection light beam is expanded only in the X-direction. The X-direction is the scanning direction in which a reticle denoted by 30 is moved past the illumination system 10 during the scanning operation. Because the light field imaged on the reticle 30, which light field is shown in FIG. 2 and denoted by 32, has a relatively small extension in the scanning direction (X-direction), the second optical raster element 28 also needs to expand the transiting projection light beam only relatively slightly in the X-direction. The second optical raster element 28 therefore not only increases the light conductance value in only one spatial direction, but additionally does so in this direction only by a comparatively small amount.

By means of a lens or lens group 34 arranged in the zoom-axicon objective 20 on the output side, the first optical raster element 16 is imaged on a first field plane 36, in which a first masking system, denoted as a whole by 38, is arranged. The first masking system 38 contains in the embodiment shown two blades extending along the Y-direction and which are adjustable, e.g. in a power-operated manner, in the X-direction. Of these two blades only one blade 40 located beyond the paper plane can be seen in the meridional section of FIG. 1. At the beginning and end of each scanning process one of these two blades is power-adjusted in the X-direction in order to ensure that the reticle 30 is exposed evenly to the desired irradiation.

It is not absolutely necessary for the first optical masking system 38 to be arranged exactly in the first field plane 36; it may also be offset from the field plane 36 by a few millimeters up to a maximum of approximately 2 cm along the optical axis denoted by 41, because a blurred imaging of the first blades 40 in scanning operation not relevant in view of the integration effect in the scanning direction which is achieved in that mode.

Arranged behind the first field plane 36 in the beam propagation direction is a second objective 42 which images the first field plane 36 on a second field plane 44 by means of a plurality of optical elements contained therein and not specifically designated. Arranged in a pupil plane 46 within the second objective 42 is a third optical raster element 48 which effects an expansion of the projection light beam in the Y-direction, i.e. perpendicularly to the scanning direction. Because, as shown in FIG. 2, the extension of the light field on the reticle 30 is large in this Y-direction, this expansion of the projection light beam is accompanied by a relatively sharp increase in the light conductance value. Because no optical elements which influence the divergence of the projection light beam are arranged after the third optical raster element 48 in the illumination system 10, the maximum light conductance value of the illumination system 10 is attained directly behind the third optical raster element 48.

A manipulator 50 with which the pupil can be influenced in a specified manner is also arranged directly before the third optical raster element 48 within the second objective 42. This manipulator may be, for example, a grey-scale filter which has locally varying grey values across the pupil.

A second masking system denoted as a whole by 52, with which the light field can be masked in the Y-direction, is arranged in the second field plane 44. For this purpose the second masking system 52 has two blades 54, 56 which are adjustable in the Y-direction. Because the blades 54, 56 are arranged exactly in the field plane 44 they are imaged with sharp edge definition on the reticle 30 by means of a following third objective 58, which is frequently referred to as a REMA objective (REMA=REticle MAsking). This imaging is achieved with the aid of a third objective 58, in the object plane of which the second field plane 44 is located and in the image plane of which the reticle 30 is located. The second masking system 52 should be arranged as precisely as possible in the field plane 44, or at least should not be offset therefrom by more than 1 mm in the direction of the optical axis 41.

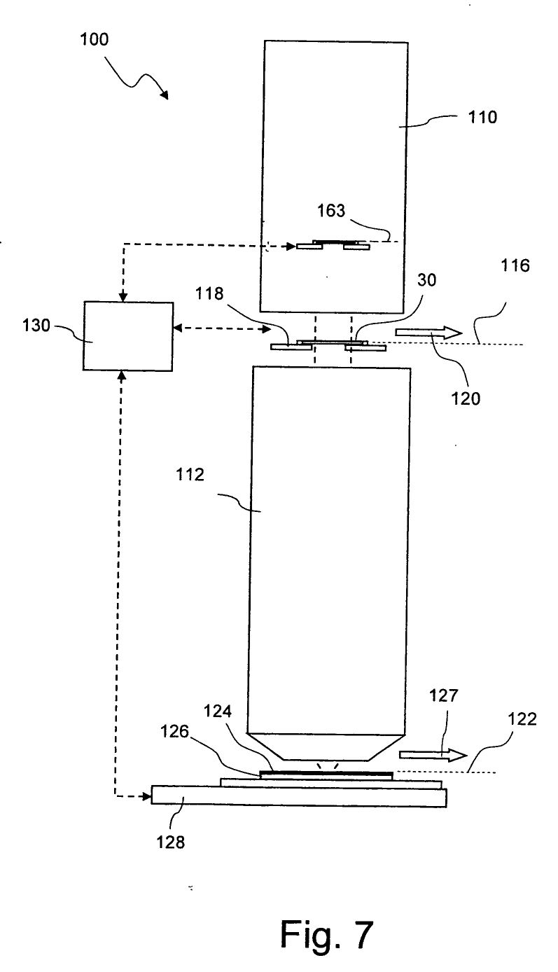

Also located in the second field plane 44 is an attenuation system 60, of the type known, for example, from the above-mentioned U.S. Pat. No. 5,473,410 A, for locally variable attenuation of the light intensity. Such an attenuation system 60 may also be spaced slightly away from the second field plane 44, because the attenuation elements contained in the attenuation system 60, e.g. blades insertable in the light field, do not need to be imaged sharply on the reticle 30. However, instead of this known attenuation system, the use of the attenuation system elucidated below with reference to FIGS. 7 to 10 may also be considered.

FIGS. 3 and 4 show the second optical raster element 28 in a plan view and in a section along the line IV-IV respectively. In this embodiment the second optical raster element 28 is in the form of a refractive element which includes a support 62 and a plurality of parallel cylindrical lenses 64 arranged thereon, which in the installed state are disposed in the Y-direction. Because the cylindrical lenses 64 have relatively slight curvature the transiting projection light is expanded only comparatively slightly in the X-direction.

FIGS. 5 and 6 show the third optical raster element 48 in a plan view and in a section along the line VI-VI respectively. The third optical raster element 48 is of similar construction to the second optical raster element 28. The third optical raster element 48 likewise includes a plurality of cylindrical lenses 68 applied to a support 66. These cylindrical lenses 68 have, however, greater curvature than the cylindrical lenses 64 of the second optical raster element 28, so that transiting projection light is expanded more strongly. In addition, the third optical raster element 48 is installed in the illumination system 10 in such a way that the longitudinal direction of the cylindrical lenses 68 is rotated through 90° with respect to the longitudinal direction of the cylindrical lenses 64 of the second optical raster element 28. The two optical raster elements 28 and 48 therefore differ not only in the degree of expansion but also through the direction in which the transiting projection light beam is expanded.

A further possibility of solving the space requirement problems in the region of the field plane in front of the masking objective is described below with reference to FIGS. 7 to 10.

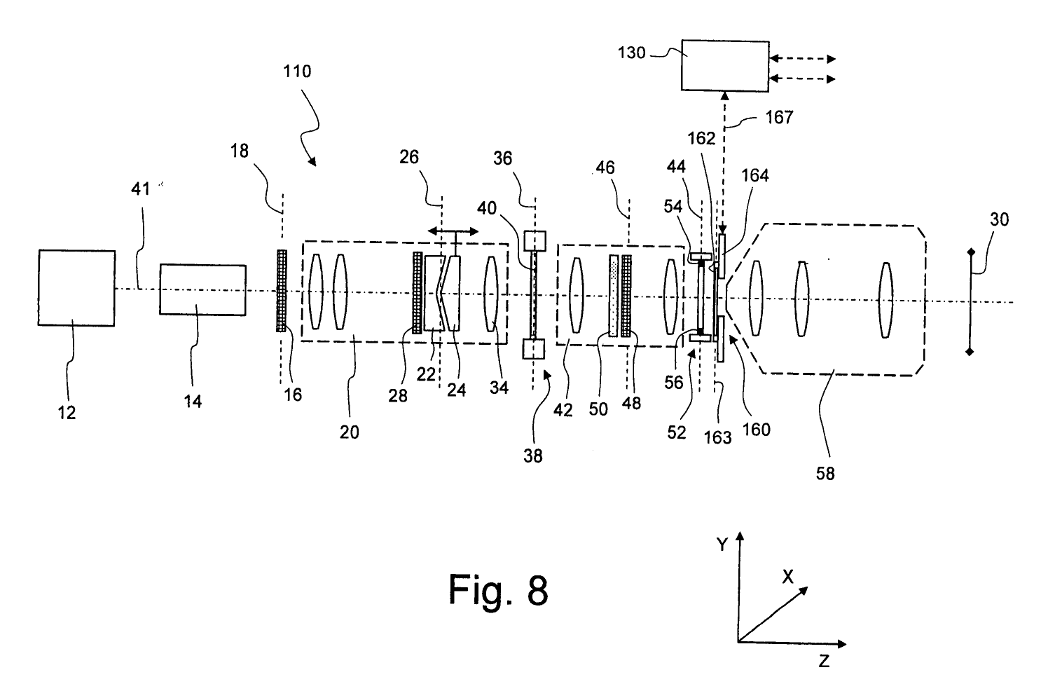

FIG. 7 shows in a highly simplified meridional section, which is not to scale, a microlithographic projection exposure apparatus denoted in its entirety by 100. The projection exposure apparatus 100 includes an illumination system 110 which is explained in more detail below with reference to FIG. 8. The projection exposure apparatus 100 also includes a projection lens 112, in the object plane 116 of which the reticle 30 is arranged movably. For this purpose there is provided a first traversing system 118 with which the reticle 30 can be moved with extreme accuracy in a direction indicated by an arrow 120 during a scanning process. Such traversing devices, also referred to as “stages”, are sufficiently known in the state of the art, so that their constructional details need not be discussed further.

Located in an image plane 122 of the projection lens 112 is a light-sensitive layer 124 which may be, for example, a photoresist. In the embodiment illustrated the projection lens 112 has a positive imaging scale of 4:1, so that the illuminated area on the reticle 30 is imaged upright but reduced by a factor of 4 on the light-sensitive layer 124 during a scanning process. The light-sensitive layer 124 is applied to a suitable support 126, e.g. a silicon wafer. The support 126 is movable in the image plane 122 by means of a second traversing system 128 which may be of similar construction to the first traversing system 118.

To control the first traversing system 118 and the second traversing system 128, the projection exposure apparatus 100 includes a control system 130 which ensures that the light-sensitive layer 124 is moved with the reticle 30 during a scanning process. As this happens, the support 126 is moved synchronously with and in the same direction, indicated by an arrow 127, as the reticle 30 by means of the second traversing system 128 during a scanning process. In this process the traversing velocity is reduced by the reduction scale of the projection lens 112. It is thereby ensured that to each point on the reticle there corresponds a point on the light-sensitive surface 124.

The illumination system 110 of the projection exposure apparatus 100 is explained in more detail below with reference to FIG. 8.

The illumination system 110 corresponds largely to the illumination system 10 shown in FIG. 1. The only difference is that an attenuation system 160, which differs from the above-described attenuation system 60 according to U.S. Pat. No. 5,895,737 A, is arranged in proximity to the image plane 44.

The attenuation system 160 includes a transmission filter 162 with locally varying transmissivity, and a third traversing system 164. By means of the latter the transmission filter 162 can be moved in a filter plane 163 synchronously with the traversing movements of the reticle 30 and therefore with the traversing movements of the support 126 during a scanning operation. For this purpose the third traversing system 164 is connected via a control line 167 to the control system 130, which synchronizes the traversing movements of the first, second and third traversing systems 118, 128 and 164 respectively. The third traversing system 164 may in principle be constructed identically to the first and second traversing systems 118, 128.

The transmissivity of the transmission filter 162 varies in such a way that when the transmission filter 162 is moved by means of the third traversing system 164 synchronously with the reticle 30 in the filter plane 163, which is at least in proximity to the field, each of the points on the light-sensitive layer 124 to be exposed is subjected to at least approximately the same irradiation, i.e. light energy per unit area.

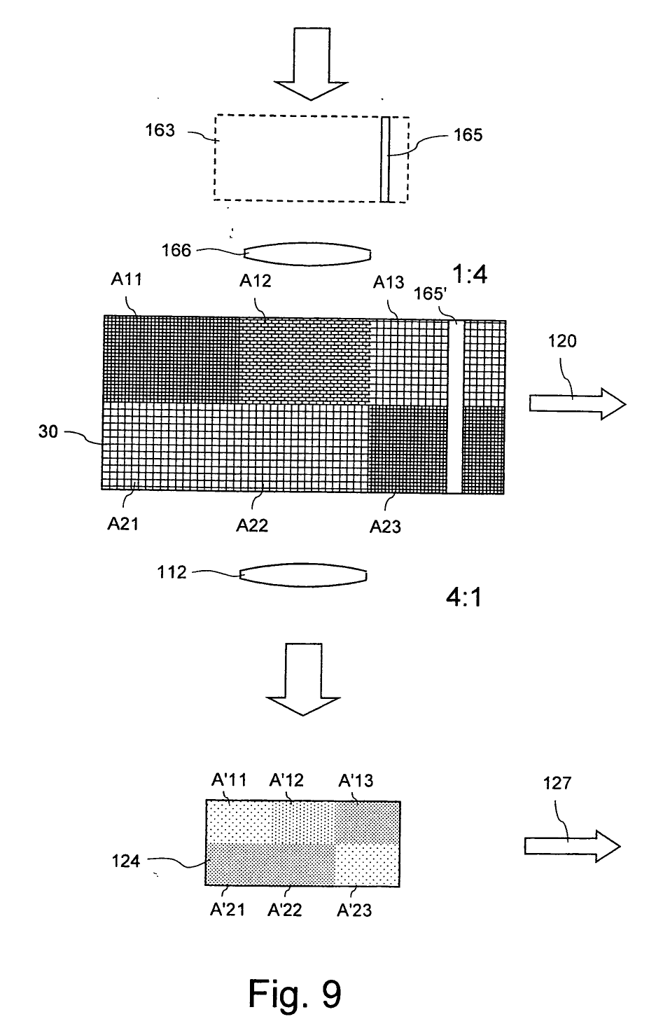

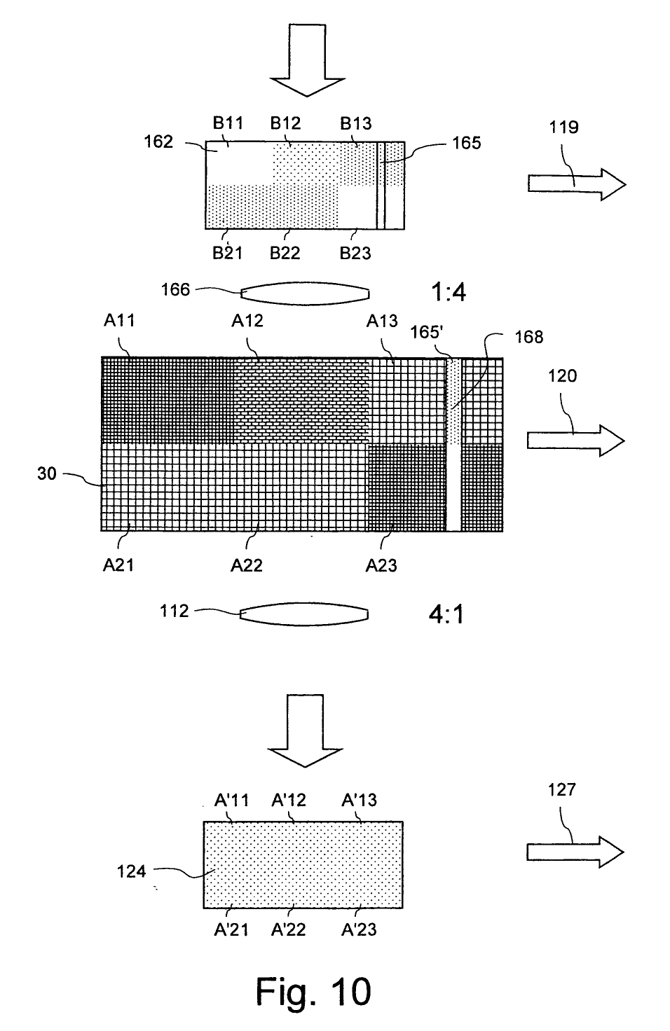

How such a transmission curve can be determined, is explained in detail below with reference to FIGS. 9 and 10.

At the top of FIG. 9 the filter plane 163, in which the transmission filter 162 can be moved, is indicated by a broken line. The vertical rectangle 165 shown on the right in the filter plane 164 is intended to indicate a slit-shaped light field which is generated by the two masking systems 38 and 52.

Indicated by a lens below the filter plane 164 is an optical system 166 which images the filter plane 164 on the field plane 116 in which the reticle 30 is moved. In the embodiment illustrated here, the optical system 166 is the REMA objective 58 shown in FIG. 8. It is assumed here for simplicity that the REMA objective 58 has an imaging scale of 1:4, whereby the filter plane 164 is imaged with fourfold magnification on the reticle 30. The optical system 166 may, however, comprise objectives or optical arrangements of a different type; what is important is that the optical system 166 provides a field plane which is conjugate to the object plane 116 in which the reticle 30 can be moved, and in which or close to which the transmission filter 162 can be moved.

Indicated by a further lens below the reticle 30, on which the image 165′ of the slit-shaped light field 165 is projected, is the projection lens 112. In the embodiment illustrated here the projection lens 112 has an imaging scale of 4:1, so that the reticle 30 is reduced by a factor of four when imaged on the light-sensitive layer 124 illustrated below the reticle 30.

To determine the locally varying transmission curve of the transmission filter 162, a normal exposure process is first carried out with the reticle 30, no transmission filter 162 being present, however, in the filter plane 164. This constellation is illustrated in FIG. 9.

It is assumed here for simplicity that the reticle 30 carries only three different types of regularly arranged structures, as is illustrated in FIGS. 9 and 10 by different patterns in the six rectangular areas A11, A12, A13 and A21, A22, A23. The imaging of the reticle 30 by the projection lens 112 on the light-sensitive layer 124 must now cause the light energy per unit area (irradiation) added up over time to be not equal at all points to be exposed during the scanning process indicated by arrows 120, 127.

In the case of the light-sensitive layer 124 shown at the bottom of FIG. 9 this is indicated by the varying density of dots in the areas A′11, A′12, A′13 and A′21, A′22, A′23 on the light-sensitive layer 124, which correspond to the differently structured areas A11, A12, A13 and A21, A22, A23 on the reticle 30. The less dense the dots in a given area, the lower is the light energy impinging on a point to be exposed in that area.

Because the light-sensitive layer 124 has a relatively sharp exposure threshold, such fluctuations in the light energy impinging per unit area cause undesired fluctuations in the width of the structures to be imaged. To avoid such fluctuations in the structure widths a transmission filter 162 is now constructed, the transmissivity curve of which is so designed over the surface of the transmission filter 162 that despite the different structures on the reticle 30 all the points to be exposed on the light-sensitive layer 124 are subjected to at least approximately the same irradiation.

For the simple example shown in FIG. 9, the transmissivity curve of such a transmission filter 162 is shown at the top of FIG. 10. The highest transmissivity, preferably being in the region of 100 percent, is possessed by the transmission filter 162 in areas B11 and B23, which correspond to the least exposed areas A′11 and A′23 on the light-sensitive layer 124. The more light energy impinges on a point on the light-sensitive surface 124 during an exposure without the transmission filter 162, the lower is the transmissivity of the corresponding point on the transmission filter 162. Consequently, the transmissivity of the transmission filter 162 is higher in area B12 and is highest in the other areas B13, B21 and B22, since the corresponding areas on the light-sensitive layer 124 are subjected to the greatest light energy, for which reason the greatest attenuation must be attained in those areas.

This relationship is also clear in the light field 165′ which is imaged on the reticle 30 by the optical system 166. During the scanning process the transmission filter 162 and the reticle 30 are moved in the direction indicated by arrows 119 and 120, but with traversing velocities differing by a factor of four, past the light fields 165 and 165′ respectively. At the position to be seen in FIG. 10, the light field 165′ on the reticle 30 is attenuated in the upper half 168 by the transmission field 162, whereby the area A13 of the reticle 30 located below same is subjected to less intensive projection light. The light energy impinging per unit area on the points to be exposed in the area A′13 on the light-sensitive layer 124 is correspondingly less. The attenuation by the transmission filter 162 is so selected that the light energy impinging per unit area on the light-sensitive layer 124 just reaches the lowest value which can be measured on the light-sensitive layer 124 without the transmission filter 162. Because of the synchronous control of the three traversing systems 118, 128 and 164 and the system of the transmission filter 162 in a field plane conjugate to the object plane 116, it is ensured that for every point on the reticle 30 the projection light impinging thereon can be attenuated in a specified manner by precisely one point of the transmission filter 162.

To measure the light energy per unit area impinging on points to be exposed, a photoresist or similar light-sensitive layer 124, which can be developed after exposure and then evaluated in known fashion in order to determine the light energy impinging on each point, may, for example, be used, as was explained above. Alternatively, a CCD sensor which adds up the impinging light energy point-by-point and over time may be used.

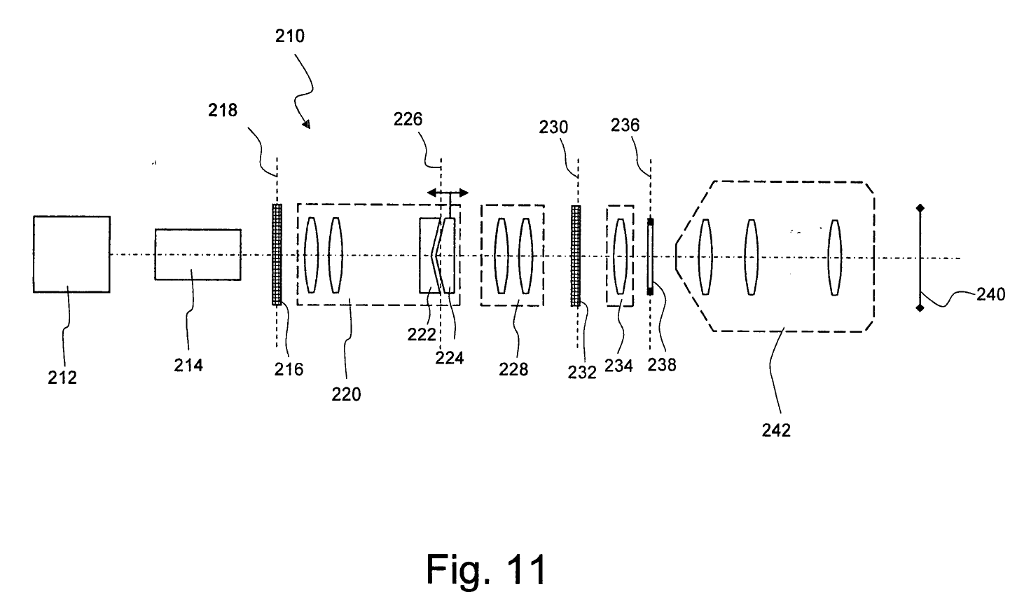

An exemplary embodiment of the invention according to a further aspect will be explained below with reference to FIG. 11, which shows an illumination system in a schematic meridian section that is not to scale.

The illumination device, denoted in its entirety by 210, has a light source 212, e.g. in the form of an excimer laser, which produces monochromatic and strongly, but not completely, collimated light with a wavelength in the ultraviolet spectral range, for example 193 nm or 157 nm.

In a beam expander 214, which may be, for example, an adjustable mirror system, the projection light generated by the light source 212 is expanded to form a rectangular and substantially parallel ray bundle. The expanded projection light then passes through a first optical raster element 216, which may be, for example, a diffractive optical element having a two-dimensional raster structure. Other types of suitable optical raster elements are described, for example, in the above-mentioned U.S. Pat. No. 6,285,443 A which is incorporated by reference. With this first optical raster element 16 the divergence distribution of the projection light coming from the light source 212 can be reshaped to provide a circular, annular or quadrupole divergence distribution.

The first optical raster element 216 is arranged in an object plane 218 of a zoom-axicon objective 220 with which the illumination angle distribution can be varied. For this purpose the zoom-axicon objective 220 includes two axicon lenses 222, 224 which are displaceable relative to one another and are arranged in a pupil plane 226 of the zoom-axicon objective 220. The illumination system 210 described so far corresponds to the illumination system 10 described above with reference to FIG. 1.

A second objective 228 is arranged in the optical path behind the zoom-axicon objective 220 and images a first pupil plane 226 onto a second pupil plane 230. A second optical raster element 232, which may for example be a refractive optical element such as a microlens array, is arranged in this second pupil plane 230. The divergence of the light emerging from the second objective 228 can be selectively increased in a directionally dependent way by the second optical raster element 32, for example in order to achieve an anamorphotic effect.

The second optical raster element 232 is also the last optical element in the illumination system 210 which modifies the geometrical extent. The maximum light conductance value achievable by the illumination system 210 is therefore obtained behind the second optical raster element 232. Between the first optical raster element 216 and the second optical raster element 232, conversely, the light conductance value is only about 1 to 10% of the light conductance value achieved behind the second optical raster element 232. Expressed more simply, this means that the light which passes through the second objective 228 is still collimated relatively strongly. The second objective 228 can therefore be constructed in a very straightforward and inexpensive way.

A third objective 234 is arranged behind the second optical raster element 232 in the light propagation direction. A reticle masking system 238, which is known as such and comprises adjustable blades, is arranged in a field plane of the third objective 236. The masking system 238 determines the geometry of the region on a reticle 240 through which projection light passes. A fourth objective 242 is provided in order to achieve sharp edges of this region, the blades of the masking system 238 being arranged in its object plane and the reticle 240 being arranged in its image plane.

If so desired, a glass rod (not shown) or a similar light mixing element for beam homogenization may be inserted between the third objective 234 and the mask system 238.

The second objective 228 may moreover be integrated, with only minor design modifications, into the illumination system known from the above-mentioned U.S. Pat. No. 6,285,443 A if the glass rod is omitted. Omission of the glass rod is feasible if the projection exposure system is only intended for scan operation, for example, for which homogenization is unnecessary at least in the scan direction. The available space obtained in the illumination system by omitting the glass rod will then be taken up by the second objective 228 and the second optical raster element 230, which is spatially offset from the zoom-axicon objective 220.

1. An illumination system for a microlithographic projection exposure apparatus, comprising:
a) a light source for generating a projection light beam, and
b) a masking system for masking a reticle, said masking system including
i) adjustable first blades for masking in a first direction, wherein the first blades are arranged in or in close proximity to a first field plane, and
ii) adjustable second blades for masking in a second direction, wherein the second blades are arranged in or in close proximity of a second field plane which is different from the first field plane.

2. The illumination system of claim 1, further comprising:
a) a first objective, which images a first optical raster element on the first field plane6, and
b) a second objective, which is arranged behind the first objective in a beam propagation direction and images the first field plane on the second field plane.

3. The illumination system of claim 2, further comprising:
a) a second optical raster element, which expands a transiting light beam exclusively in the first direction and which is arranged in the first objective, and
b) a third optical raster element which expands a transiting light beam exclusively in the second direction and which is arranged in the second objective.

4. The illumination system of claim 3, wherein the second optical raster element is arranged close to a pupil plane within the first objective, and wherein the third optical raster element is arranged close to a pupil plane of the second objective.

5. The illumination system of claim 1, wherein the first blades and the second blades define a substantially strip-shaped light field on the reticle, said light field having an extension in the first direction which is shorter than an extension in the second direction.

6. The illumination system of claim 1, further comprising an attenuation system for locally variable attenuation of the light intensity, wherein said attenuation system is arranged in the second field plane.

7. The illumination system of claim 2, wherein the first objective and the second objective are configured so that a light field illuminated in the first field plane is smaller than a light field illuminated in the second field plane.

8. The illumination system of claim 2, further comprising a manipulator arranged in the second objective for manipulating a pupil of the second objective.

9. The illumination system of claim 2, wherein the first objective is a zoom-axicon objective having two axicon lenses which are adjustable relative to one another.

10. The illumination system of claim 2, further comprising a third objective which images the second field plane on a third field plane in which the reticle is arranged.

11. A microlithographic projection exposure apparatus for imaging structures contained in a movably arranged reticle on a light-sensitive layer, comprising a transmission filter having a locally varying transmissivity and being movable synchronously with movements of the reticle.

12. The apparatus of claim 11, further comprising:
a) an illumination system for generating a projection light beam, which illumination system contains a light source and an imaging optical system,
b) a first traversing system for moving the reticle in an image plane of the optical system,
c) a projection lens for imaging structures contained in the reticle on a light-sensitive layer,
d) a second traversing system for moving a support of the light-sensitive layer,
e) a third traversing system for moving the transmission filter into or close to a field plane of the optical system, wherein said field plane is optically conjugate to the image plane,
f) a control system for controlling the traversing systems such that the reticle, the support and the transmission filter move synchronously.

13. The apparatus of claim 11, wherein a one to one correspondence is provided between each point on the transmission filter and each point on the reticle.

14. The apparatus of claim 11, wherein the transmission filter has a transmissivity distribution over its surface which is configured such that, at least approximately, the same light energy per unit area impinges on each exposed point on the light-sensitive layer.

15. A method for homogenizing the light energy which impinges per unit area on a light-sensitive surface in a microlithographic projection exposure apparatus, wherein the light-sensitive surface is configured to be arranged in an image plane of a projection lens of the projection exposure apparatus, said method comprising:
a) arrangement of a light-sensitive element in the image plane;
b) projection of a reticle on the light-sensitive element under the conditions under which microstructured components are to be manufactured using the reticle, in a scanning process in which the light-sensitive element is moved synchronously with the reticle;
c) locally-resolved determination of the light energy impinging on the light-sensitive element per unit area;
d) determination of the smallest value of light energy which has been detected in step b) for a point to be exposed on the light-sensitive element;
e) provision of a traversing system for moving a transmission filter having a locally varying transmissivity synchronously with traversing movements of the reticle;
f) determination of the local distribution of the transmissivity of the transmission filter such that, during a further projection in which the transmission filter is moved synchronously with the reticle, the smallest value for the light energy impinging per unit area determined in step c) is at least approximately achieved at all points to be exposed on a light-sensitive layer arranged in the image plane.

16. The method of claim 15, wherein the light-sensitive element is a measuring sensor.

17. The method of claim 15, wherein the light-sensitive element is a light-sensitive photoresist.

18. An illumination system for a microlithographic projection exposure apparatus comprising:
a) a light source,
b) a first objective that has a first pupil plane and includes two axicon lenses which are configured to displace relative to each other,
c) a first optical raster element which is arranged in an object plane of the first objective,
d) a second objective arranged in the optical path behind first objective and imaging the first pupil plane onto a second pupil plane, and
e) a second optical raster element arranged in the second pupil plane.

19. The illumination system of claim 18, wherein the second objective has a magnification between approximately 0.5 and approximately 2.
